(19) United States
(12) Patent Application Publication
(10) Pub. No.: US 2002/0084987 A1
(43) Pub. Date: Jul. 4, 2002

(54) Structure of a wireless mouse system

(76) Inventor: Yen Jzuhsiang, Chung Ho City (TW)

Correspondence Address: BACON & THOMAS, PLLC, 625 SLATERS LANE, FOURTH FLOOR, ALEXANDRIA, VA, 22314

(21) Appl. No.: 09/993,483

(22) Filed: Nov. 27, 2001

(30) Foreign Application Priority Data
Dec. 29, 2000 (TW) 089222812

(51) Int. Cl. G09G 5/08

(52) U.S. Cl. 345/163

(57) ABSTRACT

The present invention relates to an improvement structure of a wireless mouse system especially one usable at any time. The invention mainly comprises a wireless mouse and a receiving stand wherein the wireless mouse is designed with link buttons, a RF-TX module and rechargeable batteries matching with a RF-RX module and a charge circuit designed in the receiving stand. A signal extending wire as well as a power inserting hole are found at the outer part of the receiving stand whereas a RF-RX module and a micro-controller are found at the inner part and are separately controlled by link buttons and double LED in order to indicate receiving status. Hence, the present invention is very practical and can be easily inserted to any type of computers.

### TECHNICAL RANGE

The present invention relates to an improvement structure of a wireless mouse system especially one usable at any time.

### BACKGROUND OF INVENTION

Commonly used wireless mice are advantageous in the sense that they do not need any extending wires and have more space but are however limited to type of computers and receiving form. Receiving equipment as well as special functions are usually pre-designed in the computer but due to the rapid development of computers and common use of USB, much improvement is needed such as to enable use of wireless mice in any computers and to avoid any problems or risks of storing. Wireless mice used nowadays are limited to type of computers and cannot, therefore, be extended in use.

### SUMMARY OF INVENTION

According to the present invention of an improvement structure of a wireless mouse system mainly comprising a wireless mouse and a receiving stand wherein said receiving stand can be inserted to USB of any type of computers by means of a signal extending wire plug.

According to the present invention of an improvement structure of a wireless mouse system wherein said wireless mouse is designed with link buttons, a RF-TX module and rechargeable batteries matching with the RF-RX module and charge circuit designed in the receiving stand to avoid mutual interference.

According to the present invention of an improvement structure of a wireless mouse system wherein a signal extending wire as well as a power inserting hole are found at the outer part of said receiving stand whereas a RF-RX module and a micro-controller are found at the inner part and are separately by link buttons and double LED in order to indicate receiving status.

### DESCRIPTION OF DRAWING

FIG. 1 shows the process between the wireless mouse and the receiving stand.

### NUMERICALS

10—receiving stand

11—recharging zone

12—processing zone

13—power inserting hole

14—AC input

15—adapter DC/9V

16—power wire

17—charge circuit

18—charge LED

19—charge stand

20—RF-RX module

21—micro-controller

22—IC EEPROM

23—signal extending wire

24—USB or PS2

25—link-LED

26—link-button

30—wireless mouse

31—rechargeable battery

32—RF-TX module

33—micro-controller

34—DC/DC converter

35—optical mouse sensor X-Axis, Y-Axis

36—5-buttons

37—link-button

38—Z-Axis sensor

### MODE FOR CARRYING OUT INVENTION

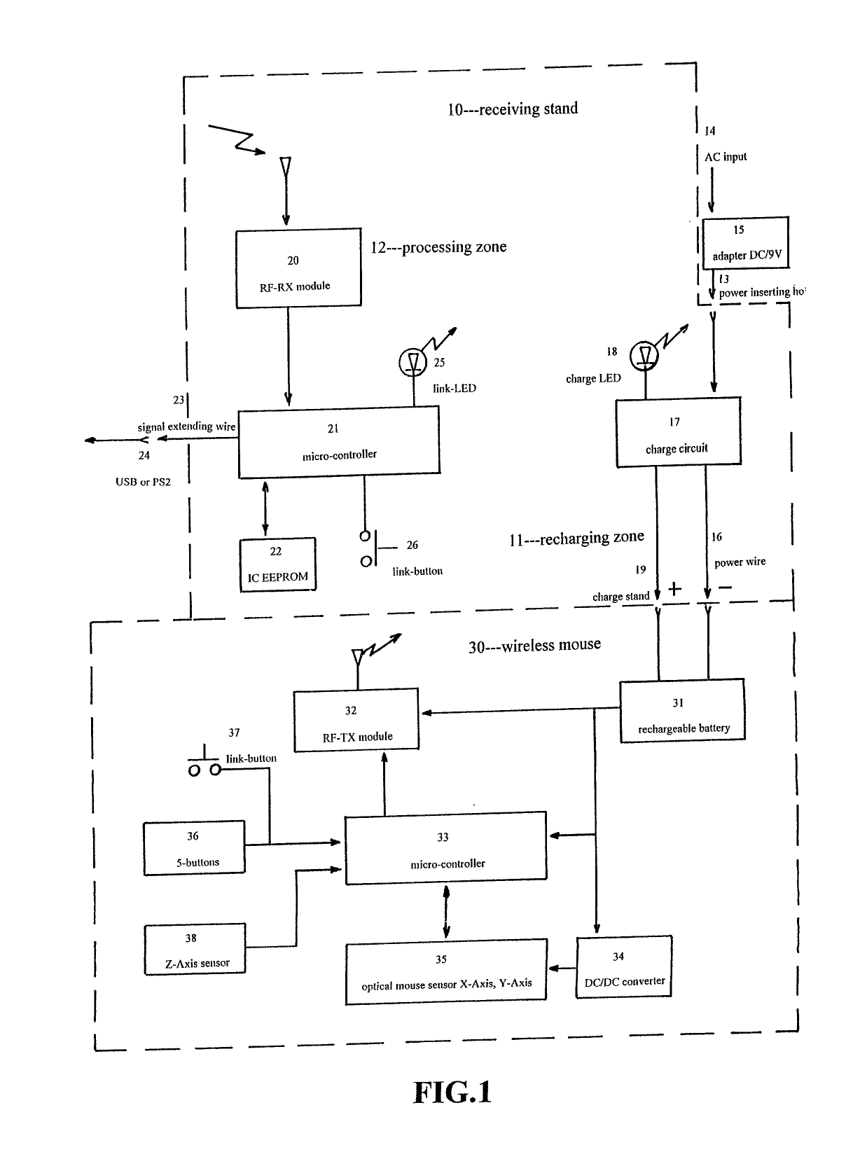

With reference to FIG. 1 showing the process between the wireless mouse and the receiving stand, the upper section relates to the process of receiving stand 10 system comprising two independent parts mainly a recharging zone 11 and a processing zone 12. Said recharging zone 11 is designed with a power inserting hole 13 for AC input 14 and going through Adapter, DC/9V 15 and power wire 16 to charge circuit 17. Further, a Charge LED 18 and a charge stand 19 are also designed to allow recharging of wireless mouse 30 to any recharging stand when not in use. The processing zone 12 is designed with a RF-RX module 20 going through a micro-controller 21 and after procedure of IC EEPROM 22, is linked to USB or PS2 24 plug; the micro-controller 21 is also designed with a link-LED 25 switched on and off by a link-button 26. With further reference to FIG. 1, the down section relates to the process of the wireless mouse 30 system and a rechargeable battery 31 is already stored in the receiving stand 10 before separation and provides power to RF-TX module 32, micro-controller 33 and DC/DC converter 34. The micro-controller 33 handles signal from optical mouse sensor X-Axis, Y-Axis 35, Z-Axis sensor 38 and 5-buttons 36 and is switched on and off by a link-button 37.

The present invention, as mentioned above, consists of a receiving stand 10 and a wireless mouse 30 functioning individually. The receiving stand 10 is generally placed beside the computer like any mobile phone recharging stand and is temporarily separated from the wireless mouse 30 when the latter is operating a computer. The receiving stand 10 acts as a signal receiving station and operates by wire signal due to a signal extending wire 23 connected to the computer motherboard. Further, the signal extending wire 23 also provides power to the receiving stand 10.

According to the present invention mainly consisting of a receiving stand 10 and a wireless mouse 30, the purpose and efficiency of such system is not limited to type of computers and is therefore very convenient as unwanted interference are avoided as long as the receiving stand 10 is matched with the wireless mouse 30.

1. An improvement structure of a wireless mouse structure mainly comprising a wireless mouse and a receiving stand wherein:
Said wireless mouse is designed with link buttons, a RF-TX module and rechargeable batteries matching with a RF-RX module and a charge circuit designed in the receiving stand;
Said receiving stand is designed with a signal extending wire and power inserting hole at the outer part whereas a RF-RX module and a micro-controller are found at the inner part and are separately controlled by link buttons and double LED in order to indicate receiving status.

2. As mentioned in claim 1 of “An improvement structure of a wireless mouse system”, said receiving stand refers to two independent sections mainly a recharging zone and a processing zone. The recharging zone is designed with a power inserting hole for power flow, AC input, adapter DC/9V with a power inserting hole for power flow, AC input, adapter DC/9V for connection to power wire and further charge circuit. Charge LED as well as a charge stand are also designed to enable recharging of wireless mouse to any recharging stand when not in use.

3. As mentioned in claim 1 or 2 of “An improvement structure of a wireless mouse system”, said processing zone is designed with a RF-RX module going through a micro-controller, and after procedure of IC EEPROM, is linked to USB or PS2 plug by means of a signal extending wire. When in use, the micro-controller is also designed with a link-LED switched on and off by a link-button.

4. As mentioned in claim 1 or 2 of “An improvement structure of a wireless mouse system”, said wireless mouse is designed with a rechargeable battery already stored in the receiving stand before separation to provide power to RF-TX module, micro-controller and DC/DC Converter. The micro-controller handles signals from optical mouse sensor X-Axis, Y-Axis, Z-Axis sensor and 5-buttons and is switched on and off by a link-button.

5. As mentioned in claim 1 or 2 of “An improvement structure of a wireless mouse system”, said receiving stand and wireless mouse function individually and the receiving stand is generally placed beside the computer like any mobile phone recharging stand and is temporarily separated from the wireless mouse when the latter is operating a computer. The receiving stand acts like a signal receiving station and operates by wire signal due to a signal extending wire connected to the computer motherboard. Further, the signal extending wire also provides power to the receiving stand.
